(19) United States
(12) Patent Application Publication
(10) Pub. No.: US 2007/0163413 A1
(43) Pub. Date: Jul. 19, 2007

(54) Steel rule die and metal sectional counter

(76) Inventors: John Salusbury, Toronto (CA); Ian Young, Agincourt (CA); John Eales, Agincourt (CA)

Correspondence Address: LAW OFFICE OF DELIO & PETERSON, LLC., 121 WHITNEY AVENUE, 3RD FLLOR, NEW HAVEN, CT, 06510, US

(21) Appl. No.: 11/334,300

(22) Filed: Jan. 18, 2006

(51) Int. Cl. B26D 1/00

(52) U.S. Cl. 83/652; 83/697

(57) ABSTRACT

A multiple segment steel rule die is provided comprising a base plate having one or more channels formed therein, cutting rules secured in the channels, scoring rules secured in the channels, and at least one counter plate for cooperating with the base plate. The counter plate has slots formed therein for receiving the scoring rules. The base plate and the at least one counter plate are removably fixed to opposite heads of a press to facilitate operation of the steel rule die. The multiple segment steel rule die produces at least two blanks from stock material during a pressing operation.

### FIELD OF THE INVENTION

The present invention relates generally to industrial cutting and stamping devices, and more particularly to a steel rule die having a composite counter.

### BACKGROUND OF THE INVENTION

Cardboard or paper boxes are typically made using steel rule dies for cutting and scoring cardboard or paper stock materials, thus severing a blank from the cardboard or paper stock. The blank has fold lines or embossing lines formed on the surface by the steel rule die so that the blank is easily folded into the form of the desired box.

Conventional steel rule dies consist of a wooden male portion of the die having steel cutting rules and steel scoring rules and a cooperating female portion that is typically a counter plate consisting of sectional incised phenolic or plastic scoring counters individually fixed on a backing sheet that is permanently adhered to the structure of the press in which the die is used. These conventional steel rule dies have counter plates that wear out quickly because the phenolic counters have a fairly short life span, thus resulting in frequent replacement costs.

Steel rule dies with a single large metal counter plate are also known. These conventional dies present the problem that the wooden male portion of the die may not properly line up with the cooperating metal female portion because of varying changes in size due to temperature and/or humidity. Additionally, as the press is used and the male and female portions of the die are broken in, the male and female portions of the die may shift differentially with respect to each other. These conventional single metal counter plates are expensive to manufacture compared to dies having the phenolic counter plate and, because of the inherent alignment problems, it is difficult to justify the increased cost. Manufacturing steel rules dies with both metal male and female portions results in a very high cost.

Accordingly, there remains a need for improvements in the art.

### BRIEF SUMMARY OF THE INVENTION

In a first embodiment, the present invention provides for a multiple segment steel rule die comprising a base plate having one or more channels formed therein, cutting rules secured in the channels, scoring rules secured in the channels, and at least one counter plate for cooperating with the base plate. The counter plate has slots formed therein for receiving the scoring rules. The base plate and the at least one counter plate are removably fixed to opposite heads of a press to facilitate operation of the steel rule die. The multiple segment steel rule die produces at least two blanks from stock material during a pressing operation. There may be at least two adjacent counter plates for cooperating with the base plate, where each of the at least two adjacent counter plates is individually adjustable in location on the press. The base plate may be formed of wood or plywood. The cutting rules, scoring rules, and/or the counter plate may be formed of steel. The steel rule die may further comprise resiliently deformable portions attached to the base plate and having a thickness larger than a height of the cutting rules. The resiliently deformable portions may be located adjacent to the cutting rules and providing for disengagement of the stock and the blanks from the cutting rules after the pressing operation is complete. The steel rule die may further comprise a steel backing plate placed in between the at least one counter plate and the press. The at least one counter plate may be a multiple segment counter plate or the adjacent counter plates may each be multiple segment counter plates. Additionally, the steel rule die may further comprise a plurality of mounting holes in the base plate for mounting the base plate on the press, a plurality of positioning holes formed in the base plate for receiving positioning pins and for positioning the counter plates; and a plurality of holes formed in the counter plates. The holes formed in the counter plates may be for receiving the positioning pins for positioning the counter plates on the press relative to the base plate.

In a second embodiment, the present invention provides for a multiple segment steel rule die comprising a plate for mounting on a first surface of a press having one or more narrow channels formed therein, steel cutting rules secured in the narrow channels where the steel cutting rules substantially define perimeters of blanks to be cut by the steel cutting rules, steel scoring rules secured in the channels residing substantially inside the perimeters, a steel backing plate for mounting on a second opposing surface of the press, and a sectional multiple segment steel counter plate for cooperating with the plate and for mounting on the steel backing plate. The sectional multiple segment steel counter plate has slots formed therein for receiving the steel scoring rules during a pressing operation of the press. The sectional multiple segment steel counter plate has at least two separate pieces. The separate pieces of the sectional multiple segment steel counter plate may be individually adjustable in location on the press for proper alignment with the opposing plate. The steel rule die may further comprise resiliently deformable portions attached to the plate and having a thickness larger than a height of the steel cutting rules. The resiliently deformable portions may be substantially located adjacent to the steel cutting rules for providing for disengagement of the stock and the blanks from the cutting rules after the pressing operation is complete. The steel rule die may further comprise a plurality of mounting holes in the plate for mounting the plate on the press, a plurality of positioning holes formed in the plate for receiving positioning pins and positioning the sectional multiple segment steel counter plate, and a plurality of holes formed in the sectional multiple segment steel counter plate. The holes may receive the positioning pins for positioning the sectional multiple segment steel counter plate on the press relative to the plate.

In another embodiment, the present invention provides for a press having opposing first and second surfaces. The press comprises a multiple segment steel rule die formed from a base plate having a plurality channels formed therein. The base plate is removably mounted on the first surface. The press further comprises steel cutting rules secured in the channels, steel scoring rules secured in the channels, a steel backing plate removably mounted on the second surface, and at least one steel counter plate attached to the steel backing plate for cooperating with the multiple segment steel rule die. The steel counter plate has slots formed therein for receiving the steel scoring rules. There may be at least two adjacent steel counter plates for cooperating with the multiple segment steel rule die where each of the at least two adjacent counter plates is individually adjustable in location on the press. The press may further comprise resiliently deformable portions attached to the base plate and having a thickness larger than a height of the steel cutting rules off of the base plate. The resiliently deformable portions may be located adjacent to the steel cutting rules. The at least one counter plate may be a multiple segment counter plate or the adjacent steel counter plates may each be multiple segment steel counter plates. The press may further comprise a plurality of mounting holes formed in the base plate for mounting the base plate on the first surface, a plurality of positioning holes formed in the base plate for receiving positioning pins and positioning the steel counter plates, and a plurality of holes in the steel counter plates. The holes in the steel counter plates may receive the positioning pins secured therein for positioning the steel counter plate on the press relative to the base plate.

In one embodiment, the present invention may offer the advantage of having counter plates that may be easily adjustable in location either on the steel backing plate or on the second surface of the press. This allows for a larger, multiple segment steel rule die to be formed on a wooden plate, therefore reducing manufacturing costs. Changes in the configuration of the wooden plate due to temperature or humidity variations are easily compensated for by individually adjusting the precise locations of the counter plates.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Reference is now made to the accompanying drawings which show, by way of example, embodiments of the present invention and in which:

FIG. 1 shows in diagrammatic form a top view of a male section of a steel rule die according to one embodiment of the present invention;

FIG. 2 shows a partial cross section through the die along the line II-II of FIG. 1;

FIG. 3 shows a perspective view of the die of FIG. 1;

FIG. 4 shows a perspective view of a female counter plate according to one embodiment of the present invention;

FIG. 5 shows a top view of the female counter plate of FIG. 4 and the male section of the steel rule die of FIG. 1 cooperating together; and

FIG. 6 shows somewhat schematically a top view of the interface between the two adjacent counter plates shown in FIG. 5.

In the drawings, like references or characters indicate like elements or components.

### DETAILED DESCRIPTION OF EMBODIMENTS OF THE INVENTION

Steel rule dies comprise cooperating male and female die portions. Each of the male and female die portions are mounted on opposite sides of a press, such that when the press is operated, a card stock placed in between the male and female die portions is pressed and a blank is severed.

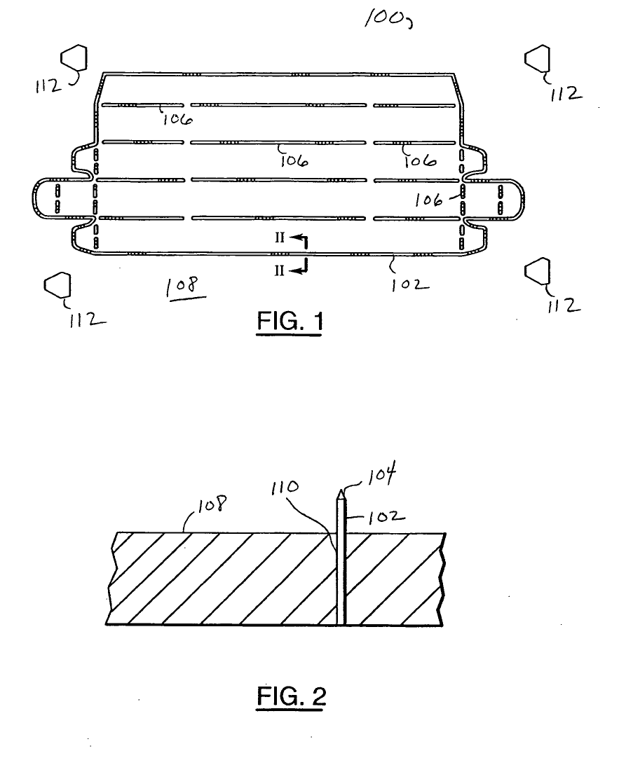

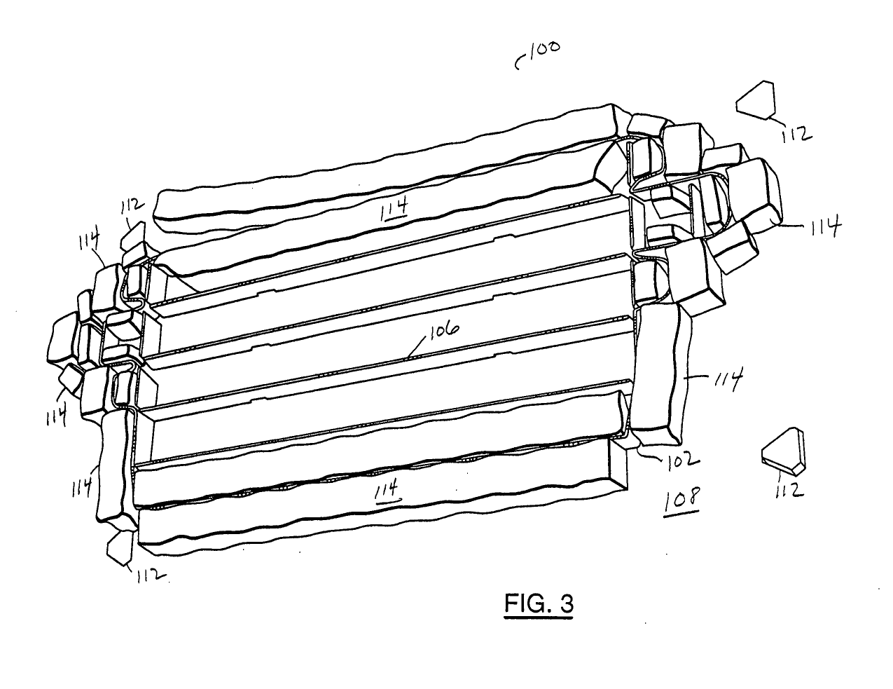

Referring to FIG. 1, a top view of a male section 100 of a steel rule die is shown according to one embodiment of the present invention. FIG. 2 shows a partial cross section through the male section 100 of the die along the line II-II of FIG. 1. FIG. 3 shows a perspective view of the male section 100 of the die shown in FIG. 1.

With reference to FIGS. 1-3, the male section 100 of the steel rule die has a cutting rule 102. In a preferred form, the cutting rule 102 has a sharp upper edge 104 forming an endless cutting edge. The cutting rule 102 defines an outside perimeter of the blank to be severed from the card stock. The male section 100 of the steel rule die further includes a number of scoring rules 106 having an upper edge that is generally rounded or blunt. The upper edge of the scoring rules 106 extends slightly above the upper edge of the cutting rules 102. The scoring rules 106 generally reside inside the perimeter defined by the cutting rule 102. The scoring rules 106 have notched ends (e.g., the upper edges of the scoring rules 106 do not meet with the sharp upper edge 104 of the cutting rule 102). The cutting rule 102 and the scoring rules 106 are typically manufactured from metal. The male section 100 of the steel rule die is formed on a base 108, for example, preferably a wooden sheet of plywood (the outline of the base 108 is not shown). The male section 100 of the steel rule die is preferably formed by laser cutting narrow channels 110 through the base 108 and then hammering the rules 102 and 106 into the channels 110. The base may further have a number of holes 112 formed therein for receiving positioning pins for use in positioning a cooperating counter plate on a press, as described below. Preferably, the holes 112 are of flat-sided or polygonal section, with their width dimensions slightly smaller than the width dimensions of the circular section pins, so that the holes 112 will strongly grip and retain the pins when the latter are forcibly pushed into the holes 112. Additionally, the base 108 may have attached resiliently deformable portions 114 (shown in FIG. 3), for example sponge or rubber, generally located around the cutting rules 102, the thickness of the portions 114 being slightly greater than the height of the scoring rules 106. While the cutting rules 102 are described as defining the perimeter of a blank to be severed and the scoring rules 106 are described as residing within the perimeter, the cutting rules 102 and the scoring rules 106 may be placed anywhere to meet the design criteria of a particular application.

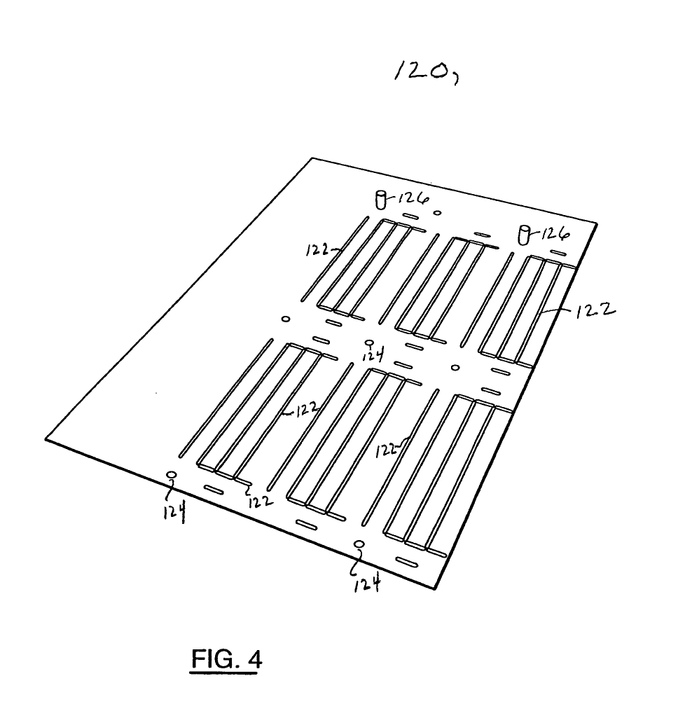

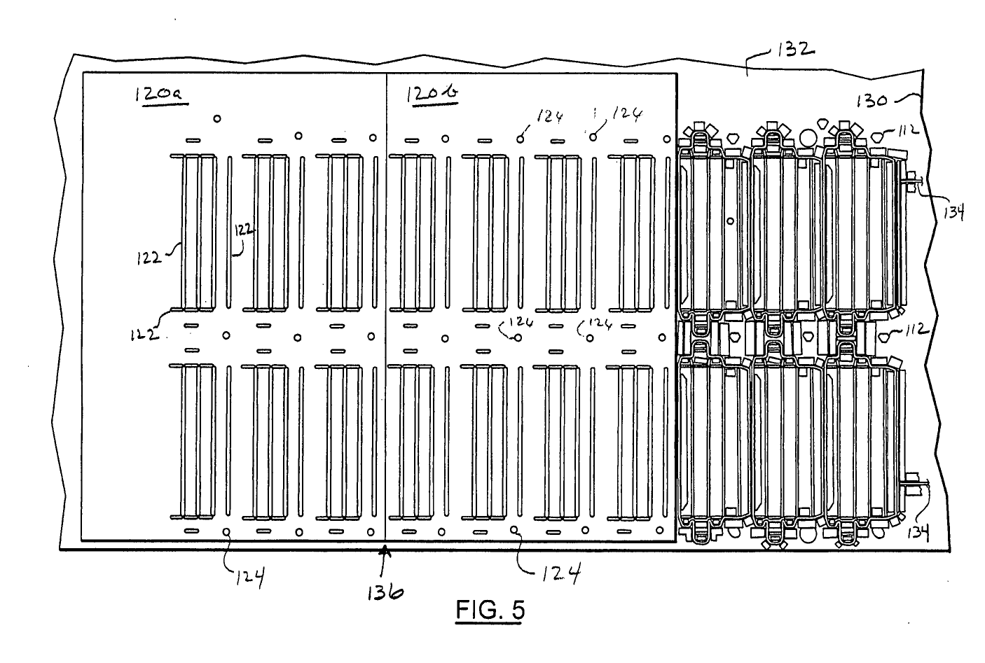

Referring to FIG. 4, a perspective view of a female counter plate 120 is shown according to one embodiment of the present invention. The counter plate 120 has a front side (shown in FIG. 4) and a back side (shown in FIG. 5) and includes a plurality of sets of slots 122 that are formed through the counter plate 120 in appropriate locations to receive the scoring rules 106 of a corresponding plurality of male sections 100 during operation of the die. The exemplary counter plate 120 shown in FIG. 4 is designed to receive an array of 6 of the male sections 100 of the steel rule die. As such, the counter plate 120 shown in FIG. 4 is a multiple segment counter plate, that is, when employed in a press, it cuts out and severs a plurality of blanks (in this case 6) from card or paper stocks with each stroke or cycle of operation of the press. In one example, the multiple segment counter plate 120 is made of steel and is mounted to the second side of the press using a steel backing plate (e.g., a “thin plate”) and/or an additional base plate. The counter plate 120 further includes a number of holes 124 formed therein for receiving one or more positioning pins 126, thus facilitating positioning of the counter plate 120 to the second side of the press relative to the male section 100 of the steel rule die while the latter is mounted to the first side of the press. Preferably, the positioning pins 126 are plastic pins that are temporarily put in place and are easily removable. In one example, the die is set up by first mounting or mechanically attaching the male section 100 of the steel rule die to the first surface of the press. The positioning pins 126 are then forcibly inserted into the holes 124. An adhesive (e.g., a glue) is placed on the back side of the counter plate 120. Ejection rings (not shown) are then placed over the pins 126. The front side of the counter plate 120 is placed in cooperating position on the male section 100 of the steel rule die by sliding the counter plate 120 with attached positioning pins 126 and ejection rings into position inside the positioning holes 112. The second surface of the press is then advanced such that the back side of the counter plate 120 contacts the steel backing plate, thus adhering the counter plate 120 in place on the steel backing plate. Upon retraction of the second surface of the press, the ejection rings ensure that the pins do not remain in the holes 124, but are instead retracted with the male section 100. Because of the use of the steel backing plate for attaching the counter plate 120 to the second side of the press, both the male section 100 of the steel rule die and the counter plate 120 are quickly and easily removable from the press, thereby facilitating an easy changeover from one die to another.

During operation of the die, the card stock is placed in between the male section 100 of the die and the counter plate 120 within the press. On closure, the press causes the male section 100 of the die and the counter plate 120 to impact opposite sides of the card stock, thus initially compressing the resiliently deformable portions 114. As the resiliently deformable portions 114 are further compressed, the sharp upper edge 104 of the cutting rule 102 impacts the surface of the card stock, penetrates the card stock, and abuts against the surface of the counter plate 120, thereby severing a blank from the continuous length of the card stock, while the slots 122 in the counter plate 120 receive the blunt ends of the scoring rules 106, thus forming scores or bending lines on the severed carton blank. On opening of the press, as the male section 100 of the die and the counter plate 120 begin to retract from one another, the resiliently deformable portions 114 begin to expand back to their normal undeformed shapes, thus forcing the cut out blank and the stock off the cutting rule 102 so that the blank and stock do not stick to the male section 100 of the die. The cooperation of the male section 100 of the steel rule die and the counter plate 120 produces a carton blank severed from the original continuous card stock that has bending lines so that the carton blank is easily folded into the shape of the desired carton.

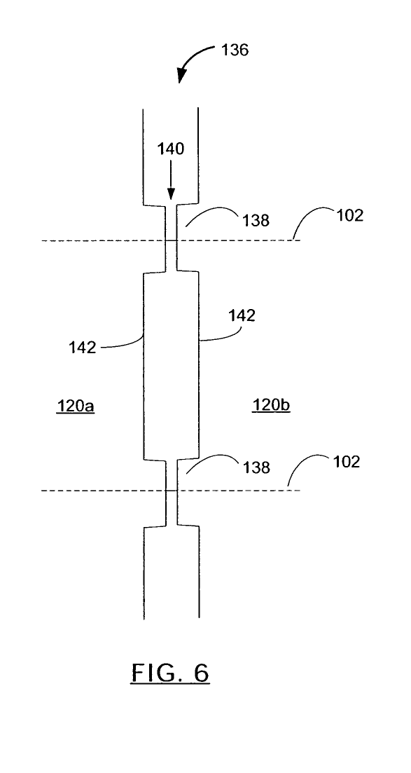

Referring to FIG. 5, a top view is shown of two of the female counter plates 120, individually indicated as 120a and 120b, and an array of the male sections 100 of the steel rule die cooperating together, as would occur in the pressing operation described above. The die shown in FIG. 5 illustrates a multiple segment die 130 having a plurality of the male portion 100 of the steel rule die formed on a single base 132. The multiple segment die 130 is shown to be partially obscured by the two adjacent counter plate sections 120a and 120b. The counter plate sections 120a and 120b include the holes 124 and the slots 122 for receiving the scoring rules 106. In the example shown in FIG. 5, the multiple segment die 130 has six male sections 100 of the steel rule die that are shown and an additional fourteen that are obscured by the counter plates 120a and 120b. Therefore, the multiple segment die 130 produces twenty blanks during the pressing operation. Likewise, the two adjacent counter plates 120a and 120b receive six and eight male sections 100 of the steel rule die, respectively. In operation, a third counter plate, similar to the counter plate 120a, is used towards the right side of the multiple segment die 130, shown in FIG. 5. While the multiple segment die 130 is shown to have 20 male portions and 20 cooperating female portions (i.e., the counter plates 120a and 120b and a third similar to the counter plate 120a) producing 20 blanks during the pressing operation, the multiple segment die 130 and the cooperating female portions may be designed to produce any number of blanks to meet the design criteria of a particular application. Optionally, the multiple segment die 130 may include one or more stripping rules 134, similar to the cutting rule 102, for aiding in breaking up the remaining card stock at the completion of the pressing operation. Additionally, the interface between the counter plates 120 (e.g., the counter plates 120a and 120b) is denoted by reference numeral 136. The interface is described in greater detail in connection with FIG. 6, below.

In one example, when the counter plates 120 are mounted in a press, the counter plates 120 are backed by a steel backing plate (not shown), which is then mounted to a base plate on the press. An advantage of mounting multiple adjacent counter plates 120 on a steel backing plate that is mounted to a press is that the placement of the counter plates 120 can be easily and individually adjusted on the backing plate to allow for precise positioning of the counter plates 120 relative to the multiple segment die 130. The structure of using multiple counter plates 120 on a steel backing plate also allows for the counter plates 120 and the multiple segment die 130 to be quickly removed from the press so that different dies can be mounted in the press. If wood is chosen as the material to be used for the single base 132 and if the configuration of the multiple segment die 130 on the single base 132 changes due to variations in humidity and/or temperature or wear, one or more of the counter plates 120 is easily repositioned on the backing plate. The counter plates 120 are easily loosened from the backing plate using an appropriate tool such as a putty knife and the adhesive is removed through cleaning. The counter plates 120 are then easily repositioned on the backing plate relative to the male section of the multiple segment die 130 using the method described above with reference to FIGS. 4 and 5, wherein the positioning pins 126 are inserted into the holes 112 and brought into register with the holes 124 in the counter plates 120. This allows wood (e.g., preferably plywood) to be used for the single base 132, therefore reducing the manufacturing cost of the die.

The use of a steel counter plate is made feasible by implementing the steel counter plate as multiple sectional counter plates (i.e., the counter plates 120). This results in a greater longevity for the counter plates (as opposed to phenolic counter plates) and results in higher quality cartons being produced. The use of multiple sectional counter plates and the fine adjustment that they provide for allows the present invention to be applied to applications using very fine scoring and cutting rules with specifications held to high tolerances. Additionally, in the event that a counter plate 120 is broken, the use of the multiple sectional steel counter plates 120 allows for only a section of the counter plates 120 to be replaced, thus resulting in reduced replacement part costs.

Referring to FIG. 6, a somewhat schematic top view is shown of the interface 136 between the counter plates 120a and 120b. The length of lands 138 and their proximity to one another are somewhat exaggerated in FIG. 6. The interface 136 is formed using the lands 138 that protrude slightly from edges 142 of the counter plates 120a and 120b. The lands 138 are used where cutting rules pass by the interface 136 and hence extend between two adjacent plates 120a and 120b. The lands 138 coincide with the cutting rules 102 and ensure that, during the pressing operation, the cutting rules 102 are able to abut against the counter plates 120 over substantially the whole of their length, thus ensuring that the cutting rules 102 perform a clean cut. By limiting the direct contact between the edges of the counter plates 120, use of the lands 138 allows for a greater potential adjustment of the positioning of the counter plates 120 on the backing plate. Preferably, any space between the lands 138 (e.g., a space 140) is kept to less than 0.010 inches to ensure a clean cut. Further, the use of the lands 138 as shown avoids possible problems that can arise when the edges 142 of the plates 120a and 120b are not entirely rectilinear and cannot be closely abutted along their entire lengths. In such cases, normally the lands 138 provide for an effective backing against which the cutting rules 102 can strike.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A multiple segment steel rule die comprising:
a base plate having one or more channels formed therein;
cutting rules secured in the channels;
scoring rules secured in the channels; and
at least one counter plate for cooperating with the base plate, the counter plate having slots formed therein for receiving the scoring rules,
wherein the base plate and the at least one counter plate are removably fixed to opposite heads of a press to facilitate operation of the steel rule die, the multiple segment steel rule die producing at least one blank from stock material during a pressing operation.

2. The multiple segment steel rule die according to claim 1, wherein there are at least two adjacent counter plates for cooperating with the base plate, each of the at least two adjacent counter plates being individually adjustable in location on the press.

3. The multiple segment steel rule die according to claim 1, wherein the base plate is formed of wood.

4. The multiple segment steel rule die according to claim 1, wherein the base plate is formed of plywood.

5. The multiple segment steel rule die according to claim 1, wherein the cutting rules and the scoring rules are formed of steel.

6. The multiple segment steel rule die according to claim 1, wherein the counter plate is formed of steel.

7. The multiple segment steel rule die according to claim 1, further comprising:
resiliently deformable portions attached to the base plate and having a thickness larger than a height of the cutting rules, the resiliently deformable portions located adjacent to the cutting rules and providing for disengagement of the stock and the blanks from the cutting rules after the pressing operation is complete.

8. The multiple segment steel rule die according to claim 1, further comprising:
a steel backing plate placed in between the at least one counter plate and the press.

9. The multiple segment steel rule die according to claim 1, wherein the at least one counter plate is a multiple segment counter plate.

10. The multiple segment steel rule die according to claim 2, wherein the adjacent counter plates are each multiple segment counter plates.

11. The multiple segment steel rule die according to claim 1, further comprising:
a plurality of mounting holes formed in the base plate for mounting the base plate on the press;
a plurality of positioning holes formed in the base plate for receiving positioning pins therein; and
a plurality of holes formed in the counter plates for receiving the positioning pins therein, the positioning pins for positioning the counter plates on the press relative to the base plate.

12. A multiple segment steel rule die comprising:
a plate for mounting on a first surface of a press, the plate having one or more narrow channels formed therein;
steel cutting rules secured in some of the narrow channels, the steel cutting rules substantially defining perimeters of blanks to be cut by the steel cutting rules;
steel scoring rules secured in the remaining channels, the steel scoring rules residing substantially inside the perimeters;
a steel backing plate for mounting on a second opposing surface of the press; and
a sectional multiple segment steel counter plate for cooperating with the plate and for mounting on the steel backing plate, the sectional multiple segment steel counter plate having slots formed therein for receiving the steel scoring rules during a pressing operation, the sectional multiple segment steel counter plate having at least two separate pieces.

13. The multiple segment steel rule die according to claim 11, wherein the separate pieces of the sectional multiple segment steel counter plate are individually adjustable in location on the steel backing plate for proper alignment with the opposing plate.

14. The multiple segment steel rule die according to claim 11, further comprising:
resiliently deformable portions attached to the plate and having a thickness larger than a height of the steel cutting rules, the resiliently deformable portions substantially located adjacent to the steel cutting rules and providing for disengagement of stock material and the blanks from the cutting rules after the pressing operation is complete.

15. The multiple segment steel rule die according to claim 11, further comprising:
a plurality of mounting holes formed in the plate for mounting the plate on the press;
a plurality of positioning holes formed in the plate for receiving positioning pins therein; and
a plurality of holes formed in the sectional multiple segment steel counter plate for receiving the positioning pins therein, the positioning pins for positioning the sectional multiple segment steel counter plate on the press relative to the plate.

16. A press having opposing first and second surfaces, the press comprising:
a multiple segment steel rule die formed from a base plate having a plurality channels formed therein, the base plate being removably mounted on the first surface;
steel cutting rules secured in the channels;
steel scoring rules secured in the channels;
a steel backing plate removably mounted on the second surface; and
at least one steel counter plate attached to the steel backing plate for cooperating with the multiple segment steel rule die, the steel counter plate having slots formed therein for receiving the steel scoring rules.

17. The press according to claim 16, wherein there are at least two adjacent steel counter plates for cooperating with the multiple segment steel rule die, each of the at least two adjacent counter plates being individually adjustable in location on the press.

18. The press according to claim 16, further comprising:
resiliently deformable portions attached to the base plate and having a thickness larger than a height of the steel cutting rules off of the base plate, the resiliently deformable portions located adjacent to the steel cutting rules.

19. The press according to claim 16, wherein the at least one counter plate is a multiple segment counter plate.

20. The press according to claim 17, wherein the adjacent steel counter plates are each multiple segment steel counter plates.

21. The press according to claim 16, further comprising:
a plurality of mounting holes formed in the base plate for mounting the base plate on the first surface;
a plurality of positioning holes formed in the base plate for receiving positioning pins therein; and
a plurality of holes formed in the steel counter plates for receiving the positioning pins therein, the positioning pins for positioning the steel counter plates on the backing plate relative to the base plate.

22. The press according to claim 16, wherein the base plate is formed of wood.
